(19) United States
(12) Patent Application Publication
(10) Pub. No.: US 2008/0038031 A1
(43) Pub. Date: Feb. 14, 2008

(54) IMAGE FORMING APPARATUS

(75) Inventor: Kohei Koshida, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/835,351

(22) Filed: Aug. 7, 2007

(30) Foreign Application Priority Data
Aug. 10, 2006 (JP) 2006-219009

(51) Int. Cl. G03G 15/00

(52) U.S. Cl. 399/406

(57) ABSTRACT

An image forming apparatus configured to correct a sheet curl with a curl correction unit disposed on a downstream of a fixing unit which fixes a toner image transferred onto the sheet by applying the sheet with heat and pressure, while the sheet is conveyed. A roller pair of the curl correction unit includes a first roller having a roller portion made of an elastomer having low thermal conductivity and a second roller having a hollow-like shape whose hardness is higher than the roller portion of the first roller and having a low heat capacity. Thus, the image forming apparatus can heat the roller pair with the heat generated by the fixing unit and maintain the warmed state.

### BACKGROUND OF THE INVENTION

1. Field of the Invention

The present invention relates to an image forming apparatus, more particularly, to an image forming apparatus configured to correct curling occurring on a sheet.

2. Description of the Related Art

In a conventional electrophotographic type image forming apparatus such as a copying machine and a printer, a toner image formed by an image forming unit is transferred onto a sheet supplied from a sheet feeding unit, and then the sheet having a toner image is conveyed to a fixing unit to fix unfixed toner on the sheet.

As one type of such a fixing unit, a conventional heat-pressure fixing unit fixes a toner image on a sheet by simultaneously applying heat and pressure to the sheet using a fixing roller and a pressure roller. In the case of using such a fixing unit, a sheet can be curled during fixing of a toner image on a sheet. Curling of sheet can cause jamming of paper in a conveyance unit, and a sheet stacking capacity of a discharge tray can seriously deteriorate.

Curling of sheet is similar to a phenomenon occurring when heat is applied to a laminated bimetal made of metals having different linear expansion coefficients. In general, curling of sheet is categorized into a heat curl and a toner curl.

The heat curl occurs due to a degree of moisture within a sheet. Especially, the heat curl occurs immediately after fixing due to a difference between an amount of water in a front side and in a back side of the sheet. The surface temperatures of a fixing roller (heat source) and a pressure roller are generally different in a conventional fixing unit. When a sheet passes through the fixing unit, the heat curl occurs due to a difference of transition in moisture absorption and desorption on both front and back sides of a sheet. This difference is caused by different amounts of heat applied to respective sides of the sheet.

A fiber material of a sheet expands when the material absorbs water and contracts when water is removed therefrom. When the transition of moisture absorption and desorption thus differs on front and back sides of a sheet, a heat curl occurs due to expansion and contraction differences of the fiber material on both sides of the sheet.

A toner curl occurs according to a change in a toner condition. In particular, a toner curl occurs due to the difference in expansion and contraction of a toner and a sheet after fixing. In general, a material for a toner includes large amount of resin components. Accordingly, a thermal expansion rate of a toner is greater than that of a sheet. Thus, a volume change rate of a toner when temperature changes is greater than a sheet. Accordingly, as a fixed sheet is cooled down, the surface of the sheet having a fixed toner image, whose volume change rate is greater than the other side, contracts due to a difference in the volume change rates relative to temperature change. Thus, a sheet curl occurs.

In this regard, Japanese Patent Application Laid-open NO. 2003-165662 discusses an image forming apparatus including a curl correction unit that curls (bends) a sheet in a direction opposite to the direction of curling of the sheet, to correct a sheet curl. FIG. 7 illustrates a configuration of such a conventional curl correction unit. The curl correction unit is disposed on a downstream of a fixing unit in a sheet conveying direction. The curl correction unit includes two curl correction rollers 203a and 203b (metallic roller 203b), which have different degrees of hardness, and a sponge roller 203c, which can come into pressure-contact with and separate from the metallic roller 203b.

The metallic roller 203b can be rotated by a drive source (not illustrated) that transmits a driving force via a drive input gear 201. The sponge roller 203c is held by a shaft supporting member 206 and separatable from the metallic roller 203b. The sponge roller 203c includes the curl correction roller 203a made of a foam silicone rubber.

The sponge roller 203c is brought into pressure-contact with the metallic roller 203b by pressure applied from pressure springs 205, which are provided at both ends of a shaft 203d, so as to form a nip portion between the sponge roller 203c and the metallic roller 203b. The metallic roller 203b bites into the sponge roller 203c to form the nip portion. The nip portion protrudes in a direction opposite to the direction of the sheet curl. The driving force is transmitted to the sponge roller 203c only by the frictional force between the metallic roller 203b and the curl correction roller 203a, into which the metallic roller 203b bites.

When the sheet having the fixed image passes through the rollers, the curl correction unit having the above-described configuration corrects the sheet curl by bending the sheet in a direction opposite to the direction of the sheet curl.

A conventional curl correction unit is provided on a downstream of a fixing unit in a sheet conveying direction. Thus, as a distance between the curl correction unit and the fixing unit becomes longer, the sheet to which heat is applied by the fixing unit can be more cooled down before reaching the curl correction unit. If the cooled sheet reaches the curl correction unit, an effect of correction of curling by the curl correction unit degrades. In order to address this problem, if the distance between the fixing unit and the curl correction unit is long, it is necessary to increase a sheet bending force to securely correct the curl, by raising a nip pressure (press-contact pressure) in the nip portion between the two rollers 203a and 203b of the curl correction unit. However, in order to apply the sheet with a high nip pressure, a high rotational driving force is required. Thus, power consumption can increase. Furthermore, in this case, it is also required to increase the strength of a mechanism for driving the metallic roller 203b. Thus, a life of the roller driving mechanism becomes short.

In addition, if the surface temperatures of the two rollers 203a and 203b are lower than the sheet temperature at the time of conveying a sheet, the curl correction performance can be lowered. Particularly, a power saving fixing unit which has recently been developed and marketed, implements a standby-less operation or low standby power consumption by lowering heat capacity. In such a fixing unit, components disposed around the fixing unit, including the curl correction unit, cannot be warmed up to a sufficient level until a print job starts.

When a print job is started in this state, if the curl correction unit has not been warmed up to a sufficient level before the sheet reaches there, the temperature of the sheet decreases. Accordingly, the effect of correcting a curl degrades.

Thus, if a sheet reaches the curl correction unit at a low temperature or if the sheet temperature is lowered at the curl correction unit, a sheet curl cannot be efficiently or securely corrected.

### SUMMARY OF THE INVENTION

The present invention is directed to an image forming apparatus capable of efficiently and constantly correcting the sheet curling.

According to an aspect of the present invention, an image forming apparatus includes a fixing unit and a curl correction unit. The fixing unit is configured to apply heat to a thermally fusable toner transferred onto a sheet and to fix the heated toner on the sheet. The curl correction unit includes a roller pair disposed on a downstream of the fixing unit in a sheet conveyance direction and configured to correct a curl of the sheet. The roller pair of the curl correction unit includes a first roller having a roller portion made of an elastomer and a second roller having a hollow shape and hardness higher than the first roller, which is in pressure-contact with the roller portion of the first roller, and wherein the second roller is heated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a configuration of an image forming apparatus according to an exemplary embodiment of the present invention.

FIG. 2 illustrates a configuration of a fixing unit of the image forming apparatus according to the exemplary embodiment of the present invention.

FIG. 3 is a schematic view of the fixing unit according to the exemplary embodiment of the present invention.

FIG. 4 illustrates a configuration of a curl correction unit of a sheet conveyance unit of the image forming apparatus according to the exemplary embodiment of the present invention.

FIG. 5 is a schematic view of the curl correction unit according to the exemplary embodiment of the present invention.

FIG. 6 illustrates an exemplary operation for correcting a sheet curl by the curl correction unit according to the exemplary embodiment of the present invention.

FIG. 7 is a schematic view of a conventional curl correction unit.

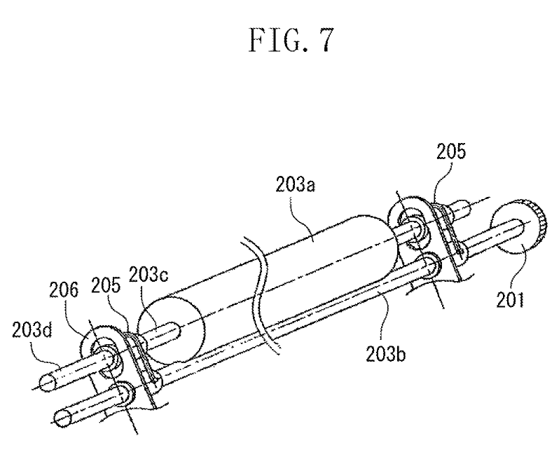

### DESCRIPTION OF THE EXEMPLARY EMBODIMENTS

Various exemplary embodiments, features, and aspects of the present invention will now herein be described in detail with reference to the drawings. It is to be noted that the relative arrangement of the components, the numerical expressions, and numerical values set forth in these embodiments are not intended to limit the scope of the present invention unless it is specifically stated otherwise.

Now, an exemplary embodiment of the present invention will be described below.

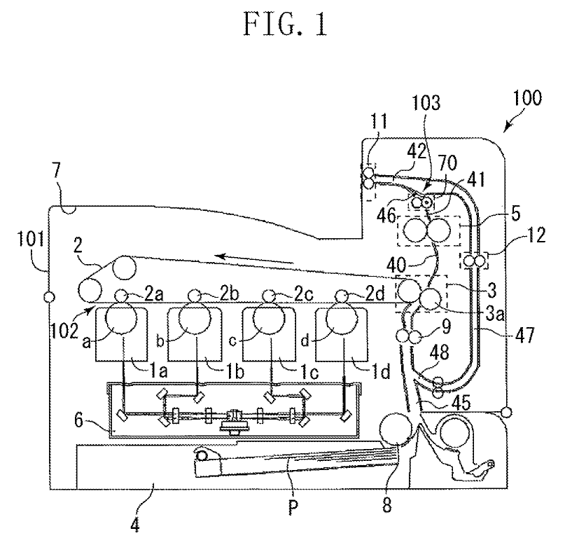

FIG. 1 illustrates a configuration of an image forming apparatus according to the exemplary embodiment of the present invention. Referring to FIG. 1, an image forming apparatus 100 includes an image forming apparatus main body 101 (hereinafter merely referred to as the “apparatus main body 100”), an image forming unit 102 configured to form an image on a sheet, and a fixing unit 5.

The image forming unit 102 includes photosensitive drums a through d and an exposure unit 6. A toner image of four colors, namely, yellow, magenta, cyan, and black, is formed on a surface of the photosensitive drums a through d. The exposure unit 6 irradiates the surface of the photosensitive drums a through d with a laser beam according to image information and forms an electrostatic latent image. Each of the photosensitive drums a through d is driven by a motor (not illustrated). A primary charging device (not illustrated), a development unit (not illustrated), and a transfer charging device (not illustrated) are provided as a unit of process cartridges 1a through 1d, and disposed around the photosensitive drums a through d.

An intermediate transfer belt 2 rotates in a direction indicated by an arrow in FIG. 1. Toner images of respective colors formed on the photosensitive drums a through dare serially multi-transferred onto the intermediate transfer belt 2 while the transfer charging devices 2a through 2d apply a transfer bias to the intermediate transfer belt 2. Thus, a full color image is formed on the intermediate transfer belt 2.

A secondary transfer unit 3 serially transfers the full color images formed on the intermediate transfer belt 2 to a sheet P. A sheet conveyance unit 103 is disposed on a downstream of the fixing unit 5. The sheet conveyance unit 103 conveys the sheet P having an image fixed thereon by the fixing unit 5. The sheet conveyance unit 103 includes a curl correction unit 70 and a discharge roller pair 11. The curl correction unit 70 is disposed on the downstream of the fixing unit 5. The discharge roller pair 11 constitutes a discharge unit (not illustrated) that discharges a sheet P, whose curl has been corrected by the curl correction unit 107, onto a discharge tray 7.

Now, processing for forming an image performed by the image forming apparatus 100 having the above-described configuration will be described below.

When a user generates an instruction for starting image forming processing, the exposure unit 6, according to image information sent from a personal computer (not illustrated), irradiates with a laser beam the surface of the photosensitive drums a through d, which is evenly charged to a predetermined polarity and at a predetermined potential, to form an electrostatic latent image. Then, the development unit develops the electrostatic latent image with the toner to visualize the image.

For example, first, the exposure unit 6 irradiates the photosensitive drum a with a laser beam generated based on an image signal of a yellow component of a document via a polygon mirror of the exposure apparatus 6 to form an electrostatic latent image in color yellow on the photosensitive drum a. Then, the development unit develops the electrostatic latent image using a yellow toner to visualize the image as a yellow toner image.

Subsequently, when the yellow toner image reaches a primary transfer portion, in which the photosensitive drum a abuts the intermediate transfer belt 2 while rotating, the yellow toner image formed on the photosensitive drum a is primarily transferred onto the intermediate transfer belt 2 by a primary transfer bias applied to the transfer charging device 2a.

Then, when a portion of the intermediate transfer belt 2 having the yellow toner image transferred thereon is moved as the intermediate transfer belt travels, a magenta toner image similarly formed on the photosensitive drum b is transferred onto the intermediate transfer belt 2 on the yellow toner image. Furthermore, cyan and black toner images are similarly transferred overlapping on the yellow and magenta toner images in the primary transferring portion as the intermediate transfer belt 2 travels. A full-color toner image is thus formed on the intermediate transfer belt 2.

Then, the sheets P, stacked in a paper feed cassette 4 during the toner image forming processing, are fed sheet by sheet by a pickup roller 8 to a registration roller 9 through a sheet conveyance path 45. A timing for conveying the sheet P is adjusted by the registration roller 9. Then, the sheet P is conveyed to the secondary transfer unit 3. The secondary transfer unit 3 collectively transfers onto the sheet P the toner images of four colors formed on the intermediate transfer belt 2 while a secondary transfer bias is applied to a secondary transfer roller 3a (i.e., the transfer unit).

The sheet P having the toner image is guided by a conveyance guide 40, which is disposed between the secondary transfer unit 3 and a fixing roller pair of the fixing unit 5, and is conveyed to the fixing unit 5. In the fixing unit 5, toners of respective color are melted and mixed together by heat and pressure to be fixed on the sheet P as a full-color image.

The sheet P having the fixed image is subjected to curl correction by the curl correction unit 70 disposed on the downstream of the fixing unit 5. Then, the corrected sheet P is discharged on the sheet discharge tray 7 through a discharge path 42 by the discharge roller pair 11.

The sheet conveyance path 45 and a sheet conveyance path between the secondary transfer unit 3 and the fixing roller pair of the fixing unit 5 constitute a main sheet conveyance path for conveying the sheet upward. The secondary transfer unit 3, the fixing roller pair of the fixing unit 5, and the curl correction unit 70 are disposed at midpoints of the main sheet conveyance path, in this order from the bottom.

Further, the image forming apparatus 100 is capable of forming an image on both sides of a sheet. In a duplex printing mode of the image forming apparatus 100, the sheet P is reversed by the discharge roller pair 11 and switched by a switching flapper 46, to be conveyed into a duplex conveyance path 47. A second curl correction unit 12 is disposed in the duplex conveyance path 47. The second curl correction unit 12 can provide a curl to the sheet P in a direction in which the sheet P is bent away from the intermediate transfer belt 2, in the secondary transfer unit 3. Subsequently, the sheet P is fed again to the registration roller 9 via a confluence portion 48 between the sheet conveyance path 45 and the duplex conveyance path 47. A toner image is formed by the image forming processing similar to that performed for a first side of the sheet.

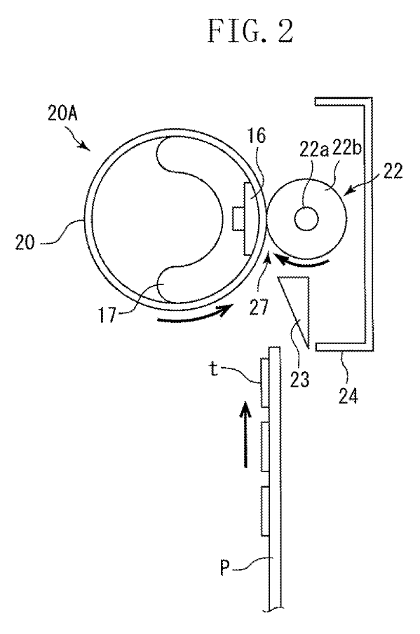

The fixing unit according to the present exemplary embodiment is of a power saving type that implements a standby-less operation. Furthermore, the fixing unit is of a fixing belt heating type and also pressing rotation member drive type (tensionless type). As illustrated in FIG. 2, the fixing unit includes a fixing belt 20 and a pressure roller 22. The fixing belt 20 is a cylinder-like shaped (i.e., endless belt-like and sleeve-like) belt member having an elastic layer on a surface. The pressure roller 22 comes into pressure-contact with the fixing belt 20.

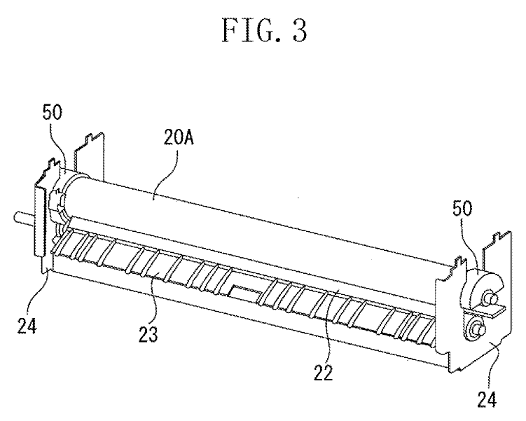

Furthermore, referring to FIG. 2, a heater holder 17 has a shape like a substantially semicircular trough in cross section and has high heat resistance and rigidity. A fixing heater 16 (i.e., heat source) is disposed along a bottom surface of the heater holder 17 in a longitudinal direction of the heater holder 17. The fixing belt 20 is loosely fitted around the heater holder 17 and is attached to apparatus frames 24. Edge portions of the fixing belt 20 are respectively urged to fixing flanges 50, as illustrated in FIG. 3.

An entrance guide 23 (FIG. 3) is attached to the apparatus frames 24. The entrance guide 23 accurately guides the sheet P that has passed through the secondary transfer unit 3 to a fixing nip portion 27. The fixing nip portion 27 is a pressure-contact portion between the fixing belt 20 and the pressure roller 22, which corresponds to a position of the fixing heater 16.

The pressure roller 22 includes a stainless core metal 22a and an elastic layer 22b formed around the stainless core metal 22a by injection molding. The elastic layer 22b is made of silicone rubber having a thickness of approximately 3 mm and covered with an approximately 40 μm-thick perfluoroalkoxy (PFA) resin tube. The pressure roller 22 is disposed between front and back side boards (not illustrated) of the apparatus frames 24, while both edge portions of the core metal 22a are rotatably held therebetween.

A fixing belt unit 20A (FIG. 3) includes the fixing heater 16, the heater holder 17, and the fixing belt 20. The pressure roller 22 is provided with the fixing belt unit 20A. The fixing heater 16 of the fixing belt unit 20A opposes the pressure roller 22.

In the present exemplary embodiment, both of the edge portions of the heater holder 17 are urged in an axial direction of the pressure roller 22 by a pressure mechanism (not illustrated), with a force of 98 N for each edge portion (196 N in total).

Thus, an outer surface of the fixing heater 16 comes into pressure-contact with the elastic layer 22b of the pressure roller 22 via the fixing belt 20, with a predetermined level of pressure which is enough to resist the elasticity of the elastic layer 22b. Thus, the fixing nip portion 27 having a predetermined width necessary for heat-fixing can be formed. The pressure mechanism has a pressure releasing mechanism (not illustrated). The pressure releasing mechanism releases the pressure of the pressure roller 22 at the time of treating with a paper jam so that a jammed sheet P can be easily removed.

The pressure roller 22 is rotated by a drive unit (not illustrated) in a direction indicated by an arrow (FIG. 2) at a predetermined circumferential velocity. Rotational force acts on the fixing belt 20 owing to a frictional force in the fixing nip portion 27 generated by pressure contact between the outer surface of the pressure roller 22 and the fixing belt 20 as the pressure roller 22 rotates.

As a result, the fixing belt 20 slides while an inner surface is in close contact with the outer surface of the fixing heater 16, and is rotated around an outer periphery of the heater holder 17 in a direction indicated by an arrow (FIG. 2). Grease is coated on the inner surface of the fixing belt 20 so that the heater holder 17 can smoothly slide on the inner face of the fixing belt 20.

Subsequently, the fixing heater 16 is powered on in a state where the fixing belt 20 is rotated as the pressure roller 22 rotates. At this time, the surface temperature of the fixing belt 20 is adjusted to 180° C. After the surface temperature of the fixing belt 20 is thus adjusted, the sheet P carrying an unfixed toner image t is guided along the entrance guide 23 to the fixing nip portion 27 between the fixing belt 20 and the pressure roller 22. In the fixing nip portion 27, the sheet P is pinched and conveyed through the fixing nip portion 27 together with the fixing belt 20. The side of the sheet P carrying the toner image t is in close contact with the outer surface of the fixing belt 20.

When the sheet P is thus pinched and conveyed, the heat generated by the fixing heater 16 is applied to the sheet P via the fixing belt 20. Accordingly, the unfixed toner image t on the sheet P is melted and fixed by heat and pressure. Then, the sheet P passes through the fixing nip portion 27 and is discharged from the fixing belt 20 by curvature separation.

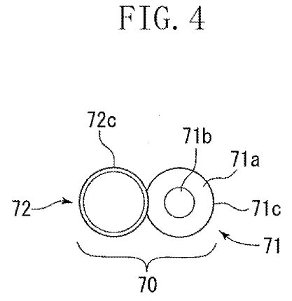

Referring to FIG. 4, the curl correction unit 70 includes a sponge roller 71 (i.e., a first roller) and a hollow roller 72 (i.e., a second roller) having a hollow tube-like shape. The sponge roller 71 comes into pressure-contact with the hollow roller 72. The sponge roller 71 has a metallic shaft 71b and a sponge-like roller portion 71a. The diameters of the metallic shaft 71b and the sponge-like roller portion 71a are 6 mm and 9 mm, respectively. The sponge-like roller portion 71a is made of foam silicone rubber (i.e., elastomer) formed on the metallic shaft 71b.

The hollow roller 72 is made of a metal such as stainless steel or aluminum which is by far harder than the roller portion 71a of the sponge roller 71, and has an outer diameter of 9 mm and thickness of 0.45 mm. In the present exemplary embodiment, in order to prevent the toner from adhering to the sponge roller 71 and the hollow roller 72, the surfaces of the sponge roller 71 and the hollow roller 72 are coated with thin fluoride resin tube layers 71c and 72c, respectively. The layers 71c and 72c have thickness of about 0.1 mm. The layers 71c and 72c can be made of polytetrafluoroethylene (PTFE) or PFA. Furthermore, the thin fluoride resin tube layers 71c and 72c that coat the surfaces of the sponge roller 71 and the hollow roller 72, have no significant influence on thermal conductivity.

The material used for the first roller is not limited to foam silicone rubber. That is, the elastomer can be made of other rubber materials or resin materials, as long as high heat resistance and large heat capacity can be obtained.

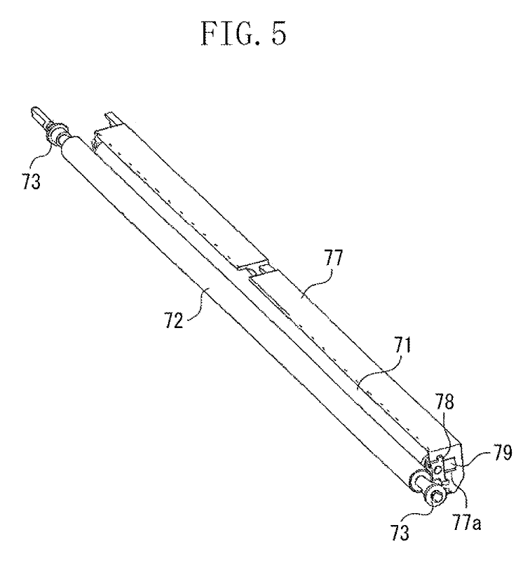

Referring to FIG. 5, both ends of the hollow tube 72 in a longitudinal direction are supported by side boards (not illustrated) via sintered bearings 73. The hollow roller 72 is rotated in the sheet conveyance direction by a drive force from a drive source which is not illustrated. Both ends of the sponge roller 71 in a longitudinal direction are held by slits 77a formed on holding members 77 via sliding bearings 78, and is movable to the hollow roller 72.

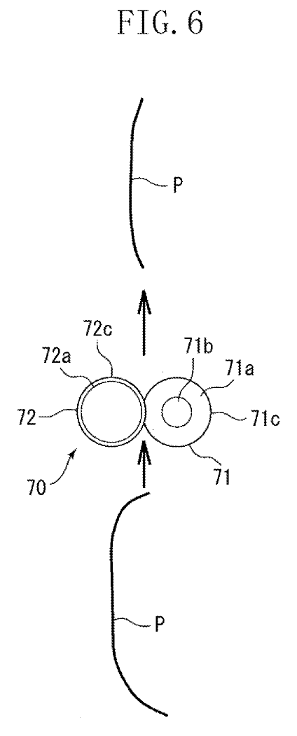

In the present exemplary embodiment, the sponge roller 71 and the hollow roller 72 are pressed by pressure springs 79 with a pressure level of 2.5 N at one end (5 N in total). A desired nip can be formed owing to the pressure between the sponge roller 71 (the roller portion 71a) and the hollow roller 72, as illustrated in FIG. 6. The hollow roller 72 bites into the sponge roller 71 to form the nip portion. The shape of the nip is formed in a direction opposite to the sheet curling direction.

Here, a curl correction effect produced by the curl correction unit 70 depends on a pressure force (mechanical energy) between the sponge roller 71 and the hollow roller 72 as well as temperature of the sheet (thermal energy). In general, in terms of mechanical energy, the lower the applied pressure, the lower the curl correction effect becomes. In terms of thermal energy, the farther the sheet P is conveyed away from the fixing unit 5, the lower the temperature of the sheet P becomes, therefore, the lower the curl correction effect becomes.

Moreover, in the case of using the fixing unit 5 according to the present exemplary embodiment, no standby mode is required. Accordingly, the fixing unit 5 and the peripheral components including the curl correction unit 70 have not been warmed up before a print job starts. As a result, when the print job starts from the state in which the fixing unit 5 and the peripheral components including the curl correction unit 70 have not been warmed up, if the curl correction unit 70 is not warmed up before the sheet P reaches the curl correction unit 70, the temperature of the sheet P decreases. Accordingly, the curl correction effect on the sheet P also declines.

In this case, when a plurality of sheets is serially printed, the degrees of curl of a first sheet and a last sheet significantly differ. Accordingly, the sheet P cannot be securely output with an appropriate state of curling.

In order to address this problem, it is necessary to warm up the curl correction unit 70 and maintain the warmed-up state when the fixing heater 16 adjusts the start-up temperature of the fixing unit 5 up to predetermined temperature.

Accordingly, in the present exemplary embodiment, the curl correction unit 70 includes the sponge roller 71 having a sponge-like shaped roller portion 71a and the hollow roller 72. The roller portion 71a has low thermal conductivity. The hollow roller 72 has a surface rigidity which is higher than the sponge roller 71, and is made of a metal of low heat capacity. Since the heat capacity of the hollow roller 72 is low, the temperature of the hollow roller 72 can be quickly raised by absorbing the heat generated by the fixing unit 5.

The sponge roller 71 can also be heated by the thus heated hollow roller 72. Since the roller portion 71a of the sponge roller 71 is made of a sponge material having low thermal conductivity, the heat on the surface of the sponge roller 71 cannot easily escape. Accordingly, the surface temperature of the sponge roller 71, which has been raised by the heat generated by the fixing unit 5 and transmitted via the hollow roller 72, can be easily maintained.

Moreover, the curl correction unit 70 is disposed between the fixing unit 5 and the discharge roller pair 11, above the fixing unit 5. Furthermore, the curl correction unit 70 according to the present exemplary embodiment is disposed at a position where a nip center distance between the curl correction unit 70 and the fixing unit 5 is 30 mm.

The heat is applied from the fixing unit 5 to the hollow roller 72 by both heat radiation and convection.

Accordingly, a guide 41 (FIG. 1) between the fixing unit 5 and the curl correction unit 70 is disposed such that a board member faces upward so as not to shut off the heat radiated from the fixing unit 5 to the hollow roller 72, and to guide upward and transmit the convection heat to the hollow roller 72.

As the curl correction unit 70 is arranged as described above, the curling of sheet can be securely performed even in the case of duplex image forming, since both sides of the sheet pass through the curl correction unit 70 warmed up by the heat that is generated by the fixing unit 5. Moreover, a greater curl correction effect can be obtained since the temperature of the sheet P is high.

Now, the curl correction processing by the curl correction unit 70 will be described below.

When a job starts from a cold state, as described above, toner images are formed on the photosensitive drums a through d. Then, the formed toner images are transferred onto a sheet P via the intermediate transfer belt 2. Then, the transferred toner images are fixed on the sheet P by the fixing unit 5.

Since the curl correction unit 70 is disposed close to the fixing unit 5 and the hollow roller 72 is made of metal with a high thermal conductivity, the heat generated by the fixing unit 5 can be effectively transmitted to rapidly raise the surface temperature of the curl correction unit 70.

Furthermore, when the sheet P having the fixed toner image thereon enters a nip of the curl correction unit 70 as illustrated in FIG. 6, the sheet P is conveyed along the shape of the nip formed by the hollow roller 72 that bites into the sponge roller 71. Thus, the sheet P is curled in a peripheral direction. The curl of the sheet P is corrected by curling the sheet P in the peripheral direction.

As described above, in the present exemplary embodiment, the roller pair 71 and 72 of the curl correction unit 70 includes the sponge roller 71 and the metal hollow roller 72 having low heat capacity. Accordingly, the curl correction unit 70 can be heated up in a short time and the warmed-up (heated) state can be maintained. Thus, a sheet curl can be effectively and securely corrected.

Moreover, in the present exemplary embodiment, the curl correction unit 70 is disposed at a position close to the fixing unit 5. Accordingly, the sheet P having passed through the fixing unit 5 cannot be cooled down and the heat generated by the fixing unit 5 can be efficiently utilized. Thus, it is not necessary to increase the pressure generated by the curl correction unit 70. Accordingly, power can be saved and a long life of the apparatus can be implemented.

In the above-described exemplary embodiment, the sponge roller 71 is disposed so as to face a non-image forming side of a sheet P and the hollow roller 72 is disposed so as to face an image forming side. However, the rollers 71 and 72 can be disposed such that the direction of correcting the sheet curl is opposite to the above-described direction, depending on tendency of a sheet curl in the image forming apparatus of the present invention.

Moreover, the outer diameters and shapes of the sponge roller 71 and the hollow roller 72, and the distance between the curl correction unit 70 and the fixing unit 5 are not limited to those described above. For example, the outer diameters and shapes of the sponge roller 71 and the hollow roller 72, and the distance between the curl correction unit 70 and the fixing unit 5 can be set depending on design conditions such as a life of the curl correction unit 70, power supplied from the image forming apparatus to the curl correction unit 70, and a surface temperature raising of the curl correction unit 70 according to the amount of heat generated by the fixing unit 5 in the case where a job is started from a cold state.

Furthermore, in the present exemplary embodiment, the fixing unit 5 is used which saves electric power. However, a commonly used heat roller fixing unit, which performs standby heating, can be used. Also in this case, the thermal energy generated by the fixing unit 5 can be efficiently utilized.

Moreover, in the present exemplary embodiment, the curl correction unit 70 is disposed between the fixing unit 5 and the discharge roller pair 11. However, the function of the discharge roller pair 11 for discharging the sheet P to an outside of the image forming apparatus can be provided on the curl correction unit 70. That is, the curl correction unit 70 can discharge the sheet P instead of the discharge roller pair 11.

Furthermore, according to a conventional method, condensation occurs on the surface of the curl correction unit 70 due to moisture (vapor) coming from the sheet P which appears immediately after fixing when warm-up is not sufficiently performed. Since the curl correction unit 70 according to the present exemplary embodiment can raise its surface temperature in a short period of time, such condensation can be prevented.

That is, since the curl correction unit 70 can raise its surface temperature in a short period of time as described above, the vapor coming from the sheet P immediately after fixing can be maintained as vapor in the vicinity of the curl correction unit 70. Accordingly, condensation can be prevented even in the case where a job starts in a cold state. Thus, transfer unevenness (image unevenness) occurring due to wet sheets caused by condensation in the case of duplex image forming can be suppressed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-219009 filed Aug. 10, 2006, which is hereby incorporated by reference herein in its entirety.

What is claimed is:

1. An image forming apparatus comprising:
a fixing unit configured to apply heat to a thermally fusable toner transferred onto a sheet and to fix the heated toner on the sheet; and
a curl correction unit including a roller pair disposed on a downstream of the fixing unit in a sheet conveyance direction and configured to correct a curl of the sheet,
wherein the roller pair of the curl correction unit includes:
a first roller having a roller portion made of an elastomer; and
a second roller having a hollow shape and hardness higher than the first roller, and being in pressure-contact with the roller portion of the first roller, and
wherein the second roller is heated.

2. The image forming apparatus according to claim 1, wherein the elastomer constituting the first roller is made of a foam material.

3. The image forming apparatus according to claim 1, wherein the second roller is made of a metal material.

4. The image forming apparatus according to claim 1, wherein
the fixing unit is disposed in a mid position of a sheet conveyance path through which a sheet is conveyed upward,
wherein the curl correction unit is disposed above the fixing unit, and
wherein the second roller is heated by the fixing unit.

5. The image forming apparatus according to claim 4, wherein
the fixing unit includes:
a fixing belt;
a fixing heater configured to heat the fixing belt; and
a pressure roller in pressure-contact with the fixing belt,
wherein a toner image transferred onto the sheet is fixed in a pressure-contacting portion between the fixing belt and the pressure roller.

6. The image forming apparatus according to claim 1, further comprising a sheet discharge unit disposed on a downstream of the fixing unit in the sheet conveyance direction and configured to discharge the sheet, wherein the curl correction unit is disposed between the fixing unit and the sheet discharge unit.

7. The image forming apparatus according to claim 1, further comprising a discharge tray disposed outside of the image forming apparatus and onto which the curl correction unit discharges the sheet.
